(19) United States
(12) Patent Application Publication
(10) Pub. No.: US 2007/0247803 A1
(43) Pub. Date: Oct. 25, 2007

(54) Portable computing device housing assembly, and associated methodology, providing for carriage of an external mass storage device

(76) Inventor: Immanuel (Ike) Eickholdt, Highland, MI (US)

Correspondence Address: SCHEEF & STONE, L.L.P., 5956 SHERRY LANE, SUITE 1400, DALLAS, TX, 75225, US

(21) Appl. No.: 11/409,640

(22) Filed: Apr. 24, 2006

(51) Int. Cl. G06F 1/16

(52) U.S. Cl. 361/685; 361/683

(57) ABSTRACT

A housing assembly, and an associated methodology, for a laptop computer, or other portable computing device. A housing face of the laptop computer includes a slotted opening, and a support bay is formed to extend into the body of the laptop computer. The support bay is of dimensions permitting reception of a thumb, or other similar, drive in supportive and protective engagement thereof. When positioned at the support bay, the thumb drive is carriable, together with the laptop computer.

The present invention relates generally to electronic computing devices, such as laptop computers or other portable computing devices, which are connectable to computer mass storage devices. More particularly, the present invention relates to an assembly, and an associated methodology, by which to provide for secure carriage of a thumb drive or other similar mass storage device. The thumb drive, or other device, is supported in releasable engagement at a support bay that extends into the body of the portable computing device. A user positions the drive at the support bay and carries the laptop, or other portable computing device, together with the thumb drive or similar drive device. The thumb drive is supportably and protectively housed at the support bay, electrically connected to the computing device when positioned at the support bay. The need for the user separately to carry the thumb drive and the laptop computer is obviated as the elements are together carriable by the user.

### BACKGROUND OF THE INVENTION

The use of personal computers and analogous computing devices is pervasive throughout modern society. Computers are capable of tirelessly performing repetitive operations through execution of algorithms by processing elements of the computing devices. The availability and use of computer processing devices have become so pervasive that many activities and services are dependent upon the ready availability and access to such devices.

As technologies associated with electronic and computing circuitry have advanced, the dimensional requirements of the elements of the computing devices have, and continue to be, reduced. And, concomitantly, the processing and storage capacities of such devices have increased. A large variety of portable computing devices have been developed, of dimensions and weights permitting their hand carriage by users. The user is able, thereby, to carry the portable computing device to a location of the user's selection and use the device once so-positioned.

Portable, hand-carriable computers, herein referred to as laptop computers, are amongst the portable computing devices that have become pervasive throughout modern society. Many users carry their laptop computers to provide for their availability for use at almost any time and at almost any location. Many laptop computers are of processing capabilities and speeds that correspond to those of conventional, personal computers that form computer workstations. Laptop computers are typically configured to include, in addition to a central processing element, mass storage devices, including, e.g., a hard disk drive and a floppy disk drive or a compact disk (CD) or digital video disk (DVD) drive. Data is storable at, and writable to, the mass storage elements. The mass storage elements are connected to the computer processing element by way of any of various mechanisms, including, for example, standardized cable connectors comporting to various protocol and configuration standards, such as the SCSI (Small Computer System Interface) or the IDE/ATA (Integrated Drive Electronics/Advanced Technology Attachment). In recent years, an external-device port, referred to as a USB (Universal Serial Bus) port has been provided on many personal computer devices and laptop computers to provide for connection to peripheral devices, such as computer mass storage devices. A peripheral device is connectable by way of the universal serial bus such that, once connected, the peripheral device forms a portion of the computer processing device. When the peripheral device forms a computer mass storage device, data is writable to the peripheral device and data is retrievable therefrom during operation of the computer processing device.

So-called, thumb drives, electronic memory circuits, sometimes formed of flash memory elements, are amongst the peripheral devices that are connectable to a portable computing device by way of a USB port. As their name implies, a thumbwheel drive is of relatively small dimensions and is sometimes otherwise referred to as a stick drive. A user is able to store, and to cause writing to, the flash, or other, memory of the thumb drive. The small size of the thumb drive permits the thumb drive conveniently to be utilized by a user to store data thereon.

However, the small dimensions of the thumb drive also results in the drive being easily overlooked and misplaced by the user. When connected to a laptop computer at a conventional USB port, the thumb drive is typically positioned to extend well beyond the housing of the laptop computer. The thumb drive is typically not carried together with the laptop computer due to the protruding nature of the thumb drive. Instead, when the laptop computer is to be transported, the user typically removes the thumb drive out of the USB port and separately carries the thumb drive separate from the laptop computer. As the thumb drive is small and easily overlooked, the user might forget to carry the thumb drive when the laptop computer is carried by the user.

If a manner could be provided by which better to provide for the transport of the thumb drive together with the laptop computer or other portable computing device, the likelihood of the user forgetting to transport the thumb drive could be reduced.

It is in light of this background information related to portable computing devices that the significant improvements of the present invention have evolved.

### SUMMARY OF THE INVENTION

The present invention, accordingly, advantageously provides an assembly, and an associated methodology, for electronic computing devices, such as laptop computers or other portable computing devices, that are connectable to computer mass storage devices.

Through operation of an embodiment of the present invention, a manner is provided that permits secure carriage of a thumb drive or other similar mass storage device.

In one aspect of the present invention, the thumb drive, or other device, is supported in releasable engagement at a support bay that extends into the body of the portable computing device. The support bay is of dimensions to receive, in supportive and protective position, the thumb drive. When positioned at the support bay, the thumb drive is further electrically connectable to circuitry of the laptop computer.

The need for the user separately to carry the thumb drive and the laptop computer is obviated. Rather, the thumb drive is supported at the support bay, protectively enclosed thereat, and electrically connected to the circuitry of the laptop computer.

In another aspect of the present invention, a housing assembly is provided that houses the electrical circuitry of the portable computer processing device. The housing assembly includes housing face surfaces that enclose the electronic circuitry. One of the housing face surfaces includes a slotted opening. The slotted opening forms an opening that extends beneath the face surface of the housing assembly. The support bay is positioned at the slotted opening and extends inwardly beneath the slotted opening. The support bay, for instance, is integrally formed with the housing assembly to form a portion thereof. The support bay defines a supportive enclosure of dimensions that permit the insertion of the thumb drive, or other mass storage drive to be positioned in the supportive and protective engagement at the support bay. That is to say, the support bay is of a configuration to form an external drive holster that holsters the thumb drive.

In another aspect of the present invention, electrical contacts, such as those provided by a USB (universal serial bus) port are positioned at the support bay such that when the thumb drive is supportively positioned at the support bay, contacts of the thumb drive contact with their corresponding contacts positioned at the thumb drive. The contacts positioned at the support bay extend to the electrical circuitry of the portable computer processing device. The electrical connections interconnect the thumb drive with the electrical circuitry to permit reading from, and writing to, the memory elements of the thumb drive. When so-connected, the thumb drive forms a logical part of the portable computing processing device.

In another aspect of the present invention, an ejector formed of a spring mechanism that generates a spring force forming an ejection force is further provided at the support bay. The ejector mechanism is selectively actuable to cause generation of the ejection forces to eject the thumb drive out of its position at the support bay. Generation of the ejection forces, applied upon the thumb drive, or other mass storage drive, causes translational movement of the drive out of its position at the support bay to release the drive therefrom. The drive, once released, is separable from the housing assembly and the portable computer processing device of which the housing assembly forms a portion. The actuation of the ejector is initiated, e.g., by a user of the portable computer processing device. A mechanical actuator, for instance, is depressed by the user to cause the ejector to generate the ejection force to cause the translation of the thumb drive out of the support bay.

In another aspect of the present invention, when election is made to eject the drive out of its position at the support bay, a signal is provided to the electrical circuitry of the portable computer processing device. The electrical circuitry, upon detection of the signal representative of the initiation of the ejection of the drive out of the support bay, performs execution of appropriate algorithms to permit the ejection without loss of memory content or interruption of other ongoing processes at the portable computer processing device. That is to say, generation of the signal indicates to the electrical circuitry that the drive is to be dismounted, and the circuitry of the portable computer processing device undertakes operations to ensure the proper dismounting of the drive. Upon completion of the performance of the dismount operations, in one implementation, the ejection forces caused to be applied to the drive positioned at the support bay to eject the drive therefrom. Alternately, an indication is provided to the user of the portable computer processing device that the drive is ready to be removed out of the support bay. And, the user causes the ejection forces to be applied upon the drive to remove the drive out of the support bay. The ejection forces are, e.g., provided by the spring forces or by extraction forces applied directly by the user to extract the drive out of the support bay. In one implementation, the thumb drive, when positioned at the support bay, has an end side that protrudes slightly beyond the face surface at which the opening is formed. The protruding part of the drive provides a hand-hold grip to facilitate the user to apply the extraction forces to eject the drive out of the support bay.

Because the drive is positionable at the support bay, and carriable together with the portable computer processing device, improved user convenience is provided as the portable processing device and the mass storage device need not be carried separately by the user.

In these and other aspects, therefore, a housing assembly, and an associated methodology, is provided for a portable computer processing device. The portable computer processing device has an electronic operating element. A housing face is positioned to cover a portion of the electronic operating element. The housing face has a slotted opening formed therealong. A support bay is positioned to extend inwardly beneath the slotted opening formed along the housing face. The support bay is configured to form an external drive holster for receiving an external drive in supportive and releasable positioning thereat.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE INVENTION

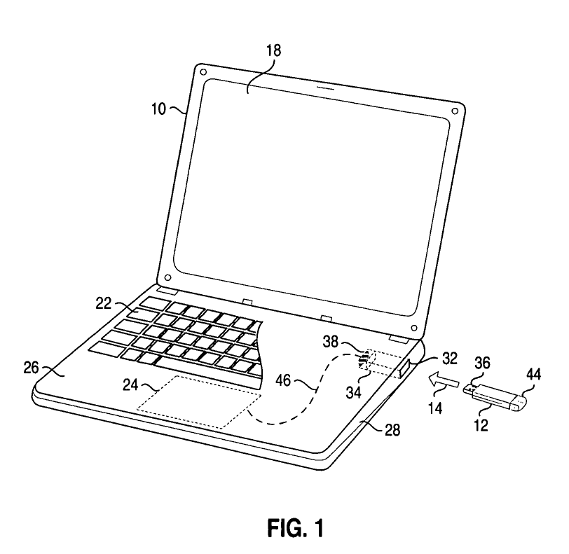

FIG. 1 illustrates a partial perspective, partial functional block, representation of a portable computer processing device positioned to receive a computer mass storage device pursuant to operation of an embodiment of the present invention.

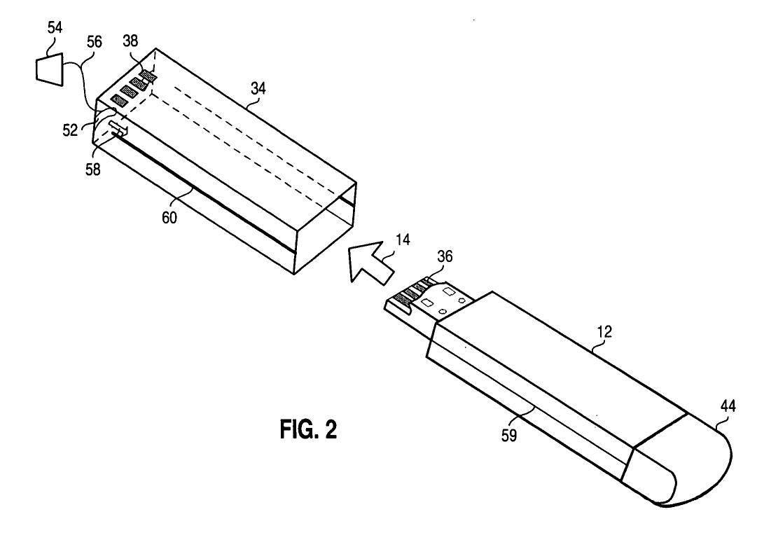

FIG. 2 illustrates a representation of a portion of the portable computer processing device showing the relationship of the assembly of an embodiment of the present invention positioned to receive the mass storage drive.

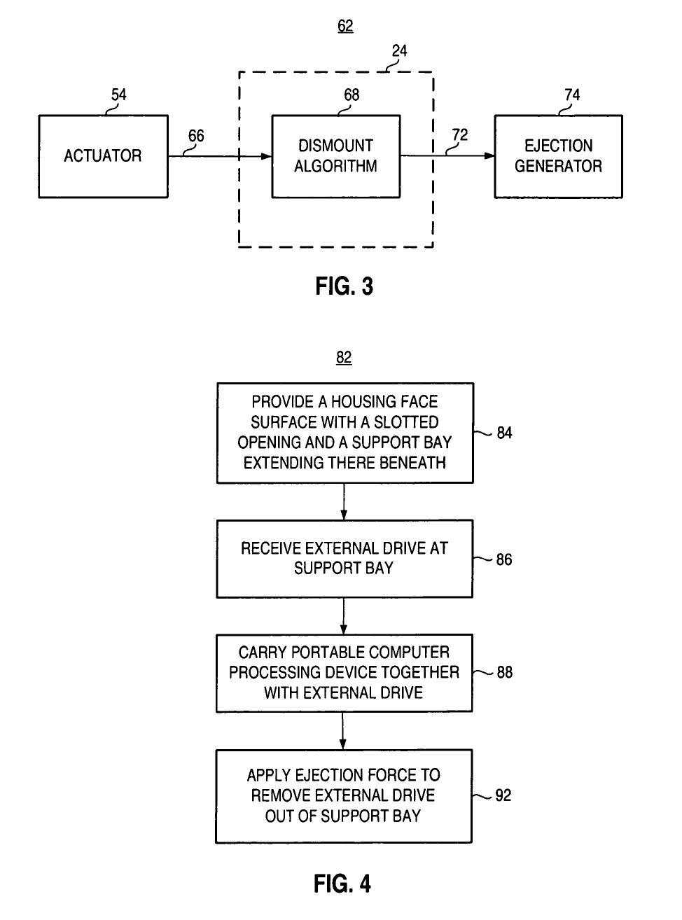

FIG. 3 illustrates a functional block diagram representative of elements of an embodiment of the present invention.

FIG. 4 illustrates a method flow diagram representative of the method of operation of an embodiment of the present invention.

### DETAILED DESCRIPTION

Referring first to FIG. 1, a laptop computer 10, representative of a portable computer processing device, is positioned to receive a thumb drive 12 when the thumb drive 12 is translated in the direction indicated by the arrow 14. While the exemplary embodiment of the present invention shall be described with respect to its implementation at a laptop computer 10, the laptop computer 10 is representative of any portable computer processing device capable of receiving a computer mass storage drive, here the thumb drive or other drive. Accordingly, the following description is merely by way of an example, and the teachings of the present invention are analogously implementable in other types or processing devices.

The laptop computer includes, in conventional manner, a display 18 and a user input actuator, here a keyboard 22. The user display and keyboard are connected to internal circuitry 24 defining an electronic operating element. The display and keyboard 18 and 22 are supported at, and the electrical circuitry 24 is supported within, a housing 26. The housing is formed of a plurality of face surfaces, typically integrally formed of a thermoplastic material. In the exemplary implementation of the laptop computer 10, a two-part housing is provided, with the individual parts hingedly coupled to one another, all in conventional manner.

A face surface of the housing 26, here a side face surface 28, includes a slotted opening 32 formed therealong. The slotted opening is of dimensions at least corresponding to the dimensions of a cross-section of the thumb drive 12. A support bay 34, formed at, and extending beneath, the slotted opening is also of dimensions at least as great as a cross-section of the thumb drive. In the exemplary implementation, the support bay is integrally formed with the face surface 28, also of a thermal plastic material. The support bay is of a lengthwise dimension to permit translation of the thumb drive into supportive positioning at the support bay such that at least a substantial portion of the thumb drive is positioned beneath the face surface 28. When the thumb drive is translated in the direction of the arrow 14 to be inserted fully into the support bay 34, the thumb drive is supportively and protectively held in position at the support bay. The support bay forms a holster for holstering the thumb drive therein.

The thumb drive 12, here a USB-compliant (universal serial bus-compliant) device that has a USB connector 36 formed at a front-end side of the drive. The front-end side of the drive is inserted into the slotted opening and translated into the support bay.

The support bay 34 includes, at a back-end face surface thereof, a USB connector 38. The USB connector 38 includes electrodes corresponding to electrodes of the USB connector 36 of the thumb drive. Plugged connection of the USB connectors 38 and 36 creates electrical connections with the flash, or other, memory locations of the thumb drive. In the exemplary implementation, the lengthwise dimension of the support bay permits seating of the front-end side of the thumb drive at the USB connector with a small portion, here indicated at 44, of the thumb drive protruding beyond the face 28 of the housing 26.

The USB connector 38 is electrically connected to the electrical circuitry 24 housed within the housing 26. The electrical connections are represented in the figure by the lines 46. When the thumb drive is positioned at the support bay and seated against the USB connector 38 to interconnect to the connectors 36 and 38, the electrical circuitry of the laptop computer is able to access the contents of the memory of the thumb drive, and the drive 12 appears to the operating system embodied at the circuitry to be an additional drive to which data can be written and from which data can be retrieved.

Because the drive 12 is positionable at the support bay to be protectively and supportively engaged thereat, a user of the laptop need not remove the drive out of its engaged position with the circuitry of the laptop computer when the laptop computer is to be transported. Rather, the user is able to merely maintain the drive in its position at the support bay and carry the laptop computer together with the engaged drive 12 and to transport the computer and drive together. The conventional need to carry the thumb drive separate from the laptop computer is obviated. And, the user is thereby less likely to forget to carry the thumb drive when the laptop computer is carried, or otherwise transported, to a new location.

FIG. 2 illustrates, in isolation, the support bay 34 and the thumb drive 12. Again, the support bay 34 is shown to be of dimensions at least corresponding to a cross-section of the thumb drive 12. And, the support bay is of lengthwise dimensions permitting translation of the thumb drive in the direction indicated by the arrow 14 such that, when the USB connector 36 of the thumb drive abuts against and connects with the USB connector 38 of the support bay, a substantial portion of the thumb drive is supportively and protectively engaged at the support bay. Here, the section 34 extends beyond the support bay. The portion 44 is of a size permitting grasping of the thumb drive by a user of the laptop computer.

In the exemplary implementation, the support bay further includes leaf springs 52. The leaf springs 52 are compressed when the thumb drive is positioned at the support bay and the USB connectors 36 and 38 interconnect. An actuator 54 is connected, here by way of mechanical linkage 56, to the springs 52. Upon actuation of the actuator, the linkage causes the springs 52 to generate spring forces in the directions indicated by the arrows 58 that form ejection forces to eject the drive 12 out of the support bay. The thumb drive, once ejected out of its engagement at the support bay is available for removal by the user of the laptop computer. In an implementation in which the support bay does not include an ejector, a user of the laptop removes the thumb drive out of the support bay by grasping the portion 44 and applying an extraction force to eject the drive out of the support bay. The extraction force and the ejection force are directed in a direction generally reverse to that of the arrow 14. The thumb drive 12 is here shown further to include a longitudinally extending tongue 59 and the support bay is here shown further to include groove 60. The tongue engages with the groove to facilitate translation into and out of the support bay.

FIG. 3 illustrates a representation, shown generally at 62, of portions of the laptop computer that includes the housing assembly of an embodiment of the present invention. Here, again, an actuator 54, is available for actuation by a user of the laptop computer when a thumb drive is to be ejected out of the support bay. Upon actuation of the actuator, a signal is generated, here represented by the arrow 66, for application to a dismount algorithm 68 of the circuitry 24 of the laptop computer.

Upon detection of the signal, the dismount algorithm performs operations to permit proper dismounting of the thumb drive 12. Performance of the dismount algorithm ensures better that the data stored at, or retrieved from, the thumb drive is not corrupted and that other operating algorithms executable at the electrical circuitry do not attempt to read data from or write data to the drive 12. Upon completion of performance of the dismount algorithm, an indication is generated, here indicated at 72, and provided to an ejection generator 74. In one implementation, an electromechanical linkage is used to cause the springs 52 to generate the spring forces forming the ejection forces. In another implementation, the signal 72 is used to cause display at the user display 18 to alert the user of the laptop computer that the drive 12 can safely be extracted out of the support bay.

FIG. 4 illustrates a method flow diagram, shown generally at 82, representative of the method of operation of an embodiment of the present invention. The method facilitates convenience of carriage of an external drive with a portable computer processing device having an electronic operating element.

First, and as indicated by the block 84, a housing face surface for the portable computer processing device is provided with a slotted opening therealong. And, a support bay is formed to extend beneath the slotted opening.

Then, and as indicated by the block 86, the external drive is received at the support bay. And, as indicated by the block 88, the portable computer processing device is carried together with the external drive received at the support bay.

Later, and as indicated by the block 92, the method further comprises the operation of applying an ejection force to the external drive to facilitate its removal out of the support bay. The ejection forces applied, for instance, responsive to user selection to remove the drive out of the support bay.

Because the drive is supported at a support bay in supportive and protective enclosure, the drive need not be removed from the laptop computer when the user of the laptop computer transports or otherwise carries the laptop computer. Misplacement of the thumb, or similar, drive is less likely.

The previous descriptions are of preferred examples for implementing the invention, and the scope of the invention should not necessarily be limited by this description. The scope of the present invention is defined by the following claims.

What is claimed is:

1. A housing assembly of a portable computer processing device having an electronic operating element, said housing assembly comprising:
a housing face positioned to cover a portion of the electronic operating element, said housing face having a slotted opening formed therealong;
a support bay positioned to extend inwardly beneath the slotted opening formed along said housing face, said support bay configured to form an external drive holster for receiving an external drive in supportive and releasable positioning thereat.

2. The housing assembly of claim 1 wherein said housing face comprises a first housing face of a housing enclosure that encloses and houses the electronic operating element.

3. The housing assembly of claim 2 wherein the portable computer processing device comprises a laptop computer and wherein the first housing face comprising said housing face comprises a side face surface of the laptop computer.

4. The housing assembly of claim 1 wherein the external drive that said support bay is configured to receive comprises a thumb drive.

5. The housing assembly of claim 1 wherein the external drive holster formed of said support bay is of dimensions, relative to dimensions of the external drive, such that, when received at the external drive holster, the external drive substantially entirely is positioned beneath said housing face.

6. The housing assembly of claim 1 wherein said support bay defines a first seating surface and wherein, when the external drive is received in the supportive and releasable positioning at said support bay, the external drive seats upon the first seating surface.

7. The housing assembly of claim 6 wherein the external drive comprises a longitudinally extending tongue member and wherein the first seating surface of said support bay comprises a longitudinally extending groove, the tongue member of the external drive engaging with the groove member of the seating surface.

8. The housing assembly of claim 1 further comprising electrical contacts dispersed at said support bay, said electrical contacts connected to the electronic operating element of the portable computer processing device, the external drive, when received at the external drive holster formed of said support bay, contacts with said electrical contacts.

9. The housing assembly of claim 1 further comprising a spring actuator positioned at said support bay, said spring actuator configured selectably to generate a spring force to impart disengagement forces to disengage the external drive out of a received position at said support bay.

10. the housing assembly of claim 9 further comprising a user-enabled actuator operable in conjunction with said spring actuator, said user-enabled actuator, when actuated, configured to initiate generation of the spring force to impart the disengagement forces to disengage the external drive.

11. The housing assembly of claim 10 wherein initiation of the generation of the spring force responsive to actuation of said user-enabled actuator is delayed for a selected period subsequent to actuation of said user-enabled actuator.

12. The housing assembly of claim 11 wherein the selected period of delay of the generation of the spring force is selected at the electronic operating element.

13. A method for facilitating convenience of carriage of an external drive with a portable computer processing device having an electronic operating element, said method comprising the operations of:
providing a housing face surface for the portable computer processing device with a slotted opening therealong and a support bay extending beneath the slotted opening;
receiving the external drive at the support bay; and
carrying the portable computer processing device together with the external drive received at the support bay.

14. The method of claim 13 wherein the external drive comprises a thumb drive and wherein the support bay provided during said operation of providing is of dimensions to receive and support the thumb drive.

15. The method of claim 13 further comprising the operation of applying an ejection force to the external drive to facilitate removal of the external drive out of the support bay.

16. The method of claim 15 wherein said operation of applying the ejection force is performed responsive to user selection and wherein said method further comprises the operation of selecting to remove the external drive out of the support bay.

17. The method of claim 16 wherein said operation of removing is performed a selected period subsequent to selection during said operation of selecting to remove the external drive.

18. The method of claim 13 wherein said operation of receiving the external drive at the support bay further comprises electrically connecting the external drive to the portable computer processing device.

19. The method of claim 18 further comprising the operation of accessing contents of the external drive when received at the support bay.

20. A laptop computer comprising:
an electronic operating element;
a housing configured to supportively house said electronic operating element, said housing having a housing face that includes a slotted opening formed therealong;
a support bay positioned to extend inwardly beneath the slotted opening formed along the housing face;
a thumbwheel drive releasably supported at said support bay, said thumbwheel drive, when supported at said support bay, positioned substantially entirely beneath the housing face.
